(19) United States
(12) Patent Application Publication
(10) Pub. No.: US 2007/0119868 A1
(43) Pub. Date: May 31, 2007

(54) Pumping and floating pistons coated with a barrier layer

(76) Inventor: Hans Kraemer, Buehl (DE)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(21) Appl. No.: 10/570,974

(22) PCT Filed: Sep. 9, 2004
(86) PCT No.: PCT/EP04/10171

§ 371 Date: Jan. 9, 2007

(30) Foreign Application Priority Data
Sep. 11, 2003 (GB) 0321332.9

(51) Int. Cl. G01F 11/00; B67D 5/42

(52) U.S. Cl. 222/256; 222/386

(57) ABSTRACT

Pumping and floating pistons (70) suitable for a hand pump (10) for a viscous fluid material such as a toothpaste, made of a plastics material coated with a barrier layer (75). A preferred barrier layer is a thermoplastic elastomer. The barrier layer of the pumping piston may be integrally formed into a one way outlet valve. The barrier layer reduces leakage of components of the fluid material out through the piston, or ingress of environmental components through the piston.

This invention relates to dispensing pumps for viscous fluid materials, in particular for viscous fluid materials being dentifrices such as toothpastes and tooth-cleaning gels.

For a long time dentifrices such as toothpastes and tooth-cleaning gels have been provided for use contained in hand-operated dispensing pumps. For example toothpaste is provided by the applicant under the name Aquafresh™ in such pumps.

Such pumps are disclosed in for example GB-A-2152152, and generally comprise a tubular pump body comprising a cylindrical body wall (part 12 in GB-A-2152152) typically made of a stiff plastics material such as polypropylene (PP) or polyethylene-terephthalate (PET) containing the material to be dispensed.

In most such pumps adjacent the upper end of the body is a pumping piston (part 28 in GB-A-2152152) which can be urged downwards by the user applying pressure on an actuator part which bears on the pumping piston. The pumping piston normally includes a conduit (part 30 in GB-A-2152152) through which, when the pumping piston bears downwards upon the fluid material content, the fluid material is extruded toward an outlet opening at a downstream end of the conduit. The actuator is normally provided with a return spring means so that when the user ceases to apply pressure to the actuator the return spring means returns the pumping piston upwardly.

Because the flow conduit is narrow, and because sometimes also a closure is provided for the flow conduit which closes the outlet opening as the pumping piston is moved upwardly, the upward return movement of the pumping piston applies a suction force to the remaining fluid material in the pump body which draws this material upward along the pump body. Consequently a second piston called in the art a “follower” or “floating piston” (part 16 in GB-A-2152152) is provided in the pump body adjacent the lower end of the mass of material in the body, and this piston is drawn upwards by the suction force as the pumping piston moves upwardly. To prevent the mass of fluid material in the pump body from being urged downwardly by the pumping piston in its downward stroke the floating piston is provided with a one-way means (e.g. part 18 in GB-A-2152152), typically a metal spider spring attached to the lower surface of the floating piston having barbs at the outer ends of the spider legs which catch against the inner surface of the pump body wall on any attempt to urge the spider spring downwards, but deflect to allow the floating piston to slide upwardly. Such pumps are normally provided to be stood and used in a vertical orientation with the pumping piston above the floating piston, and terms like upper and lower are used accordingly in this description, though of course the pump may be used in any orientation.

EP-A-0 330 928 and EP-A-0 330 929 disclose pumps of different construction but having a pumping piston respectively 17, 21, and in which the body wall may be a multi layer material incorporating a layer of a gas barrier material.

The pumping piston is generally made of plastics material especially low-density polyethylene (LDPE) and the floating piston is generally made of plastics material especially of high-density polyethylene (HDPE) primarily because of the low friction of LDPE and HDPE.

There is a problem in that LDPE and HDPE are relatively permeable materials. This permeability can result in some of the ingredients, e.g. flavourants, of modem toothpastes or dental gels diffusing out through the pumping and/or floating pistons after the pump has been filled with the paste or gel. Also materials in the environment such as atmospheric gasses and water vapour can diffuse in through the pumping and/or floating pistons to cause degradation of the contents.

It is an object of this invention to provide improved pumping and floating pistons and pumps using them.

According to this invention a pumping piston suitable for a hand pump for a viscous fluid material is provided, being made of a plastics material and wherein at least part of the plastics material of the pumping piston is coated with a barrier layer.

This invention also provides a floating piston suitable for a hand pump for a viscous fluid material, being made of a plastics material and wherein at least part of the plastics material of the floating is coated with a barrier layer.

The barrier layer comprises a material different to the plastic material of the pumping piston or floating piston, and which has a lower permeability toward a component of the viscous fluid material and/or toward a component of the environment, than the permeability to the component(s) of the plastic material.

A typical pumping piston comprises a wall part adapted to extend across the interior of the body of a pump within which it is located, a peripheral rim of the wall part being adapted to make a sliding viscous fluid material proof sealing contact with the inner surface of the pump body wall, and a flow conduit via which viscous fluid material content may flow from the interior of the pump body along a flow path from the interior of the body toward a dispensing opening. Typically the flow conduit comprises an opening through the wall part communicating with a tubular member formed integrally with the wall part and defining the flow path.

In this construction of pumping piston the barrier layer may cover all or part of the wall part, and/or the peripheral rim and/or the conduit.

For example the barrier layer may cover all or part of the upper and/or lower surface of the wall part of the pumping piston, preferably covering only the lower surface i.e. the surface normally in contact with the fluid material.

For example the barrier layer may cover all or part of the inner and/or outer surface of the conduit of the pumping piston, preferably only covering the inner surface i.e. the surface normally in contact with the fluid material.

A typical floating piston comprises a wall part adapted to extend across the interior of the body of a pump within which it is located, a peripheral rim of the wall part being adapted to make a sliding viscous fluid material proof sealing contact with the inner surface of the body wall, and a one way means to allow only upward movement of the piston. Typically the one way means is provided to engage with the inner surface of the body wall.

In this construction of floating piston the barrier layer may cover all or part of the wall part and/or the peripheral rim of the floating piston.

For example the barrier layer may cover all or part of the upper and/or lower surface of the wall part of the floating piston, preferably covering only the upper surface i.e. the surface normally in contact with the fluid material.

Normally the peripheral rim of the pumping or floating piston has a frustro-conical or bi-frustro-conical cone apex-to-apex profile, the conical apex-base axes being aligned up-down, the rim having an inner surface, and an outer surface making the sliding seal with the inner surface of the pump body. Because of the desirable low friction between the HDPE or LDPE material normally used for the pumping piston preferably the barrier layer does not contact the body wall of the pump, and for example may be only on the surface of the rim which is not in contact with the body wall of the pump.

However the barrier layer may be a material having a low friction with the inner surface of the body wall and able to form a sliding seal with the inner surface of the body, and part of the rim which forms the sliding seal may be made of the material of the barrier layer. For example when the rim is of the above-mentioned conical or bi-frustro-conical apex-to-apex profile a conical profiled part of the rim may be made of the material of the barrier layer.

The barrier layer may be made of any material which has a lower permeability toward a component of the viscous fluid material and/or toward a component of the environment, than the permeability toward the component(s) of the plastic material of the pumping or floating piston respectively, e.g. lower permeability than that of HDPE or LDPE respectively if these are the materials the pistons are made of Suitable barrier layer materials include metals, e.g. thin metal foil e.g. aluminium. Such metal foils may be bonded to such plastics materials e.g. by stamping in a known manner.

A preferred barrier layer material is a polymer material. It is well known in the plastics materials art to make articles (e.g. toys, toothbrushes) from two polymer material components by means of multi-component injection moulding.

Suitable polymer materials for the barrier layer include PP, PET, silicones, ethylene vinylacetate, thermoplastic polyurethanes (“TPU”), polyamides (“PA”) such as nylon, ethylene vinyl alcohol copolymer (EVOH), polyvinylidene chloride, and in particular thermoplastic elastomers (“TPE”) such as styrene (ethylene/butadiene) styrene (“SEBS”) polymers. TPE materials are well known which can bond to plastics materials such as LDPE and HDPE and are preferred barrier layer materials. Examples of such TPE materials include Santoprene™. Suitably a barrier layer of a polymer material such as a TPE may be 0.4-1.5 mm thick.

Therefore a further aspect of this invention provides a process for making a pumping piston or a floating piston as described above wherein a plastics material part of the piston is made first incorporating the wall part, and is then enclosed in a mould defining the shape of the barrier layer, and the barrier layer of an injectable polymer material is formed by injecting the barrier layer material into the mould to form the barrier layer in contact with and bound to the wall part.

When the barrier layer on the pumping piston is a resiliently flexible material such as a resiliently flexible polymer, such as an elastomer e.g. a TPE, such a material can be additionally or alternatively used to provide a valve in the flow path.

Therefore in a further aspect of this invention a pumping piston is provided made of a plastics material comprising a wall part adapted to extend across the interior of the body of a pump within which it is located, a peripheral rim of the wall part being adapted to make a sliding viscous fluid material proof sealing contact with the inner surface of the body wall, and a flow conduit via which viscous fluid material content may flow from the interior of the pump body along a flow path toward an outlet end of the conduit, wherein a valve made of a resilient flexible polymer material different from the plastics material and biased to allow flow from the interior of the pump body toward the dispensing opening is provided in the flow path.

Preferably the valve is a flap valve i.e. comprising a resilient flap biased to open in response to flow of fluid material toward the dispensing opening and closed to flow in the opposite direction. Such a flap valve may comprise two or more convergent flaps biased closed against each other and which part in response to flow toward the dispensing opening, e.g. a so-called duckbill valve. Such a valve is suitably provided in or adjacent to the conduit.

Preferably the resilient flexible polymer material different from the plastics material is an elastomer material preferably a TPE.

Such a valve may be made by a two-component moulding process, so that the resilient flexible polymer material is bonded to the material of the piston.

For example a barrier layer of a resiliently flexible polymer material on the pumping piston may be integrally formed with such a valve. For example a barrier layer on the lower surface of the pumping piston may be integrally formed with such a valve.

Such a valve helps to further reduce loss of materials from the fluid material content and/or diffusion in of materials from the environment.

Such a valve may be made by a process for making a pumping piston wherein a plastics material part of the piston is made first, and is then enclosed in a mould defining the shape of the valve, and the valve made of an injectable resilient flexible polymer material different from the plastics material is formed by injecting the valve material into the mould to form the valve. By using suitable materials e.g. HDPE for the piston and TPE for the valve and appropriate two-component moulding conditions the valve and piston may be made such that the piston and valve are bonded together.

Provision of a valve made of such material and in such manner appears to novel, although it is otherwise known e.g. from EP-A-0 084 638 to provide a flap valve in the outlet conduit.

Other features of the pumping and floating pistons, e.g. dimensions, overall shape etc., may be typical of conventional known pumps.

The present invention also provides a dispensing pump for a viscous fluid material, in particular for a dentifrice such as a toothpaste or tooth-cleaning gel, provided with a pumping piston and/or a floating piston as described herein.

The invention will now be described by way of example only with reference to the accompanying drawings.

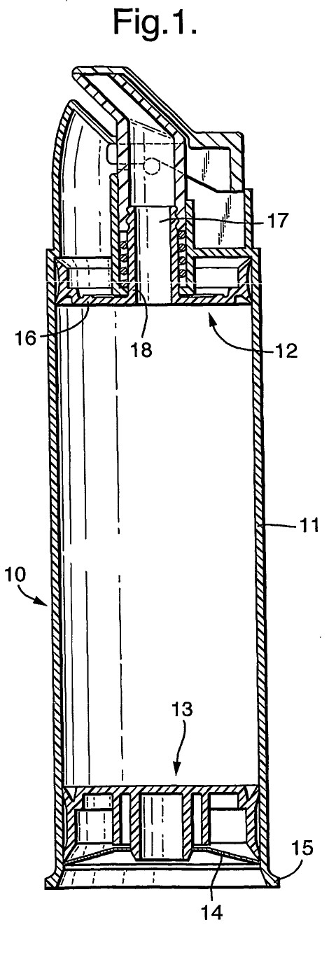

FIG. 1 shows a longitudinal sectional view of a toothpaste pump.

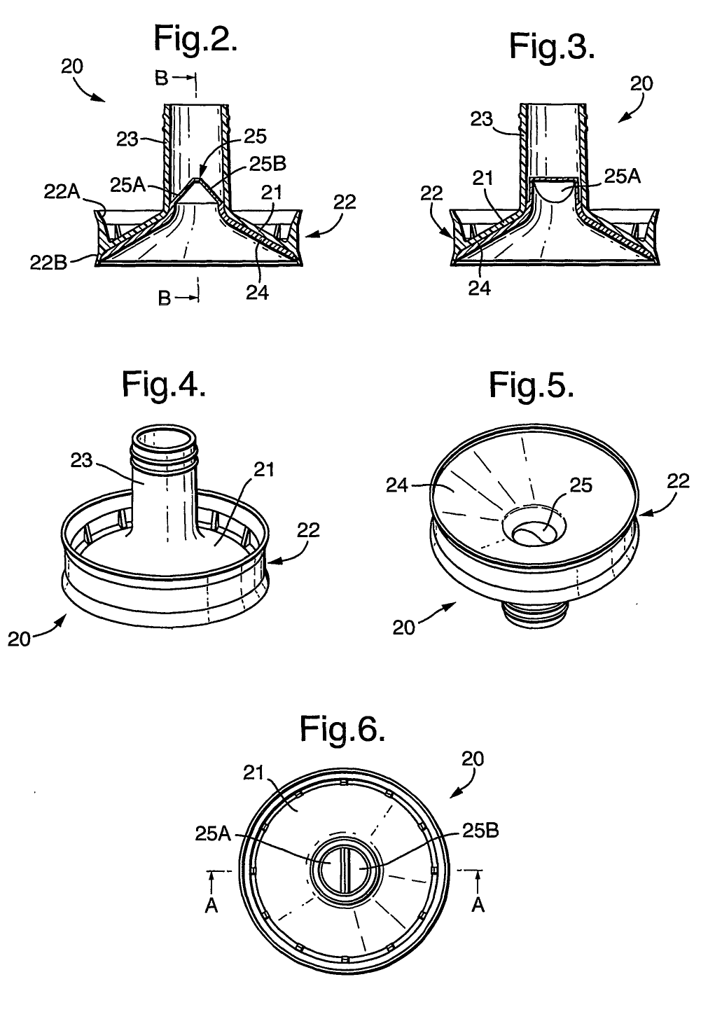

FIGS. 2-6 show various views of a pumping piston

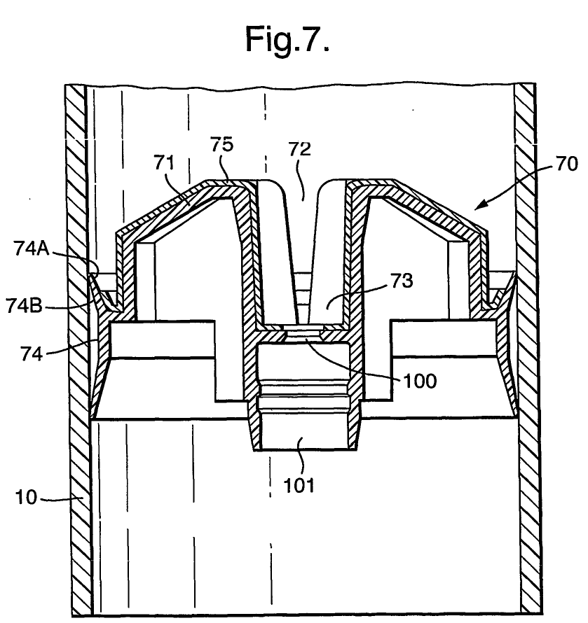

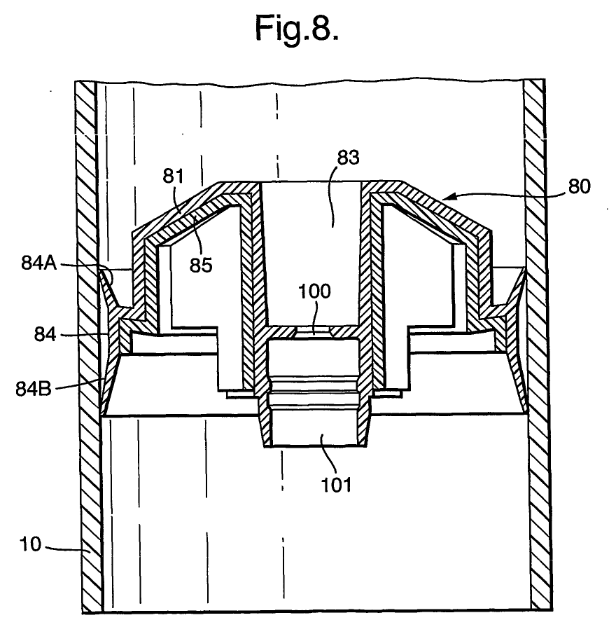

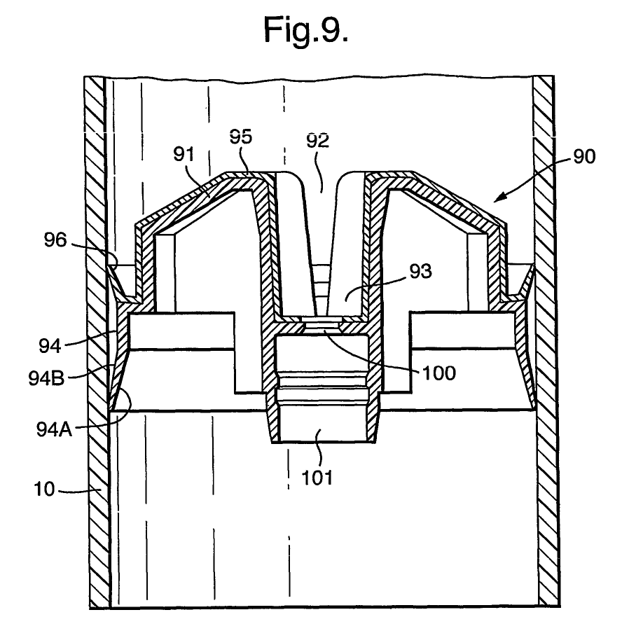

FIGS. 7, 8 and 9 show sectional views of floating pistons.

Referring to FIG. 1 a longitudinal sectional view of a toothpaste pump having a body 10 is shown, reproducing FIG. 1 of GB-A-2152152 in which the construction and operation are comprehensively described. The pump body 10 is cylindrical and comprises a cylindrical body wall 11. The pump of FIG. 1 has a pumping piston 12 and a floating piston 13 with a one way means 14 being a spider spring. The pump is configured to be stood upright on its base 15 so that pumping piston 12 is above floating piston 13. The pumping piston 12 comprises a wall part 16, through which passes a conduit 17, defined by an integral tubular member 18.

Referring to FIGS. 2-6 a pumping piston 20 of the invention suitable for use as the pumping piston 12 in FIG. 1 is shown in longitudinal sectional views in FIGS. 2 and 3, in a top perspective view in FIG. 4, in a bottom perspective view in FIG. 5 and a downward looking plan view in FIG. 6.

Pumping piston 20 has a wall part 21 adapted to extend across the interior of the body of the pump 10 within which it is located. The wall part 21 has a peripheral rim 22 which is adapted to make a sliding viscous fluid material proof sealing contact with the inner surface of the wall 11 of the body 10 of the pump. The peripheral rim 22 has a known bi-frustro-conical cone apex-to-apex profile, the conical apex-base axes being aligned up-down with an inner surface 22A, and an outer surface 22B making the sliding seal with the inner surface of the pump body of pump 10.

The piston 20 has a flow conduit 23 via which viscous fluid material content may flow from the interior of the pump body along a flow path indicated by the arrow from the interior of the body toward a dispensing opening. The conduit 23 is provided by forming the wall part 21 integrally into the tubular conduit 23 in a known manner.

A barrier layer 24 covers all of the lower surface of the wall part 21 i.e. the surface normally in contact with the fluid material, and integrally extends over part of the inner surface of the conduit 23 i.e. the surface normally in contact with the fluid material as it flows through the conduit 23. The barrier layer 24 also covers the lower inner surface 22A of the rim 22, i.e. of the lower frustro-conical profiled rim 22, so that the part of the rim 22 which makes the sliding seal with the inner surface of the body of pump 12 is free of the barrier layer material.

The pumping piston 20 is integrally made of a conventional HDPE material as known in the art for making pumping pistons. The barrier layer material 24 is a thermoplastic elastomer material, ca. 0.1-0.4 mm thick.

As seen in FIGS. 2-6, barrier layer 24 is a resiliently flexible thermoplastic elastomer material and is used to provide a valve 25 in the flow path. The valve 25 is a flap valve comprising two convergent flaps 25A, 25B biased closed against each other and which part in response to flow toward the dispensing opening, e.g. a so-called duckbill valve. The valve 25 is within the conduit 23 adjacent the lower, inlet opening, end 23A of the conduit.

FIGS. 7, 8 and 9 show sectional views of floating pistons 70, 80, 90 suitable for use as the floating piston 13 of FIG. 1. These floating pistons 70, 80, 90 each comprise a wall part 71, 81, 91 adapted to extend across the interior of the body of a pump 10 within which piston 70, 80, 90 is located. The upper surface of the wall part 71, 81, 91 of each floating piston 70, 80, 90 is profiled to mate with the lower surface of the pumping piston 20 so that when the floating piston 70, 80, 90 reaches the top of its movement up the body 10 minimum fluid material is trapped between the floating piston 20 and pumping piston 70, 80, 90, except that in a known manner the wall part 71, 91 is shaped into three 120° spaced radially extending indents 72, 92 in the upper surface, and the wall parts 71, 81, 91 have a central well 73, 83, 93. Each piston 70, 80, 90 has a peripheral rim 74, 84, 94 adapted to make a sliding viscous fluid material proof sealing contact with the inner surface of the wall 11 of the pump body 10. The peripheral rim 74, 84, 94 of each floating piston 70, 80, 90 has a bi-frustro-conical cone apex-to-apex profile, the conical apex-base axes being aligned up-down. The rim 74, 84, 94 has an inner surface 74A, 84A, 94A, and an outer surface 74B, 84B, 93B making the sliding seal with the inner surface of the wall 12 of pump body 10.

In the floating piston 70 a barrier layer 75 is provided covering all of the upper surface of the wall part 71 of the floating piston 70, including the inner surfaces of the indents 72 and the well 73 i.e. the surfaces normally in contact with the fluid material. The barrier layer 75 also covers the lower part of the inner surface of the rim 74.

In the floating piston 80 a barrier layer 85 is provided covering all of the lower surface of the wall part 81 of the floating piston 80, including the outer surfaces of the well 83 i.e. the surfaces opposite those normally in contact with the fluid material. The barrier layer 85 also covers part of the lower part of the inner surface of the rim 84.

In the floating piston 90 a barrier layer 95 is provided covering all of the upper surface of the wall part 91 of the floating piston 90, including the inner surfaces of the indents 92 and the well 93 i.e. the surfaces normally in contact with the fluid material. Upper, i.e. leading edge, frustro-conical part 96 of the rim 94 which forms the sliding seal is also made of the material of the barrier layer 95.

The floating piston 70, 80, 90 is integrally made of a conventional LDPE material as known in the art for making floating pistons. The barrier layer material 95 is a thermoplastic elastomer material, ca. 0.4-1.1 mm thick.

Each of the floating pistons 70, 80, 90 has a small hole 100 and a socket 101 in the bottom of the well 73, 83, 93. This is a known feature and has two functions, firstly the hole 100 allows air to vent when the body of the pump 10 is filled with the viscous fluid material via its lower open end and the floating piston 70, 80, 90 is then also inserted via this open lower end, and secondly the hole 100 and socket 101 function as an engagement socket for a known plug (not shown) which both closes the hole 100 when filling is complete and the piston, 70,80,90 has been inserted and functions in a known manner as a mounting for a one way means such as the known spider spring which engages with the inner surface of the body to allow only upward movement of the piston.

What is claimed is:

1. A pumping piston suitable for a hand pump for a viscous fluid material, made of a plastics material, and wherein at least part of the plastics material of the pumping piston is coated with a barrier layer.

2. A pumping piston according to claim 1 which comprises a wall part adapted to extend across the interior of the body of a pump within which it is located, a peripheral rim of the wall part being adapted to make a sliding viscous fluid material proof sealing contact with the inner wall surface of the body, and a flow conduit via which viscous fluid material content may flow from the interior of the pump body along a flow path from the interior of the body toward a dispensing opening, and in which the barrier layer covers all or part of the wall part, and/or the peripheral rim and/or the conduit.

3. A pumping piston according to claim 2 wherein the barrier layer covers all or part of the lower surface of the wall part of the pumping piston.

4. A pumping piston according to claim 2 or 3 wherein the barrier layer covers all or part of the inner surface of the conduit of the pumping piston.

5. A pumping piston according to claim 2 wherein the rim has an inner surface, and an outer surface making the sliding seal with the inner surface of the pump body and the barrier layer is only on the inner surface of the rim.

6. A floating piston suitable for a hand pump for a viscous fluid material, made of a plastics material, and wherein at least part of the plastics material of the floating piston is coated with a barrier layer.

7. A floating piston according to claim 6 which comprises a wall part adapted to extend across the interior of the body of a pump within which it is located, a peripheral rim of the wall part being adapted to make a sliding viscous fluid material proof sealing contact with the inner wall surface of the body, and a one way means to engage with the inner surface of the body to allow only upward movement of the piston, wherein the barrier layer covers all or part of the wall part and/or the peripheral rim of the floating piston.

8. A floating piston according to claim 7 wherein the barrier layer covers all or part of the upper and/or lower surface of the wall part of the floating piston.

9. A floating piston according to claim 6 or 7 wherein the rim has an inner surface, and an outer surface making the sliding seal with the inner surface of the pump body and the barrier layer is only on the inner surface of the rim.

10. A pumping piston according to claim 1 wherein the barrier layer is a material which has a lower permeability toward a component of the viscous fluid material and/or toward a component of the environment, than the permeability toward the component(s) of the plastic material.

11. A pumping piston according to claim 1 wherein the barrier layer is a material having a low friction with the inner surface of the body and able to form a sliding seal with the inner surface of the body, and part of the rim which forms the sliding seal is made of the material of the barrier layer.

12. A pumping piston or floating piston according to claim 1 wherein the barrier layer material is a metal or a polymer material.

13. A pumping piston or floating piston according to claim 12 wherein the barrier layer material is a polymer material selected from polypropylene, polyethyleneterephthalate, a silicone, ethylene vinylacetate, thermoplastic polyurethane, polyamide or a thermoplastic elastomer.

14. A pumping piston suitable for a hand pump for a viscous fluid material made of a plastics material comprising a wall part adapted to extend across the interior of the body of a pump within which it is located, a peripheral rim of the wall part being adapted to make a sliding viscous fluid material proof sealing contact with the inner wall surface of the body, and a flow conduit via which viscous fluid material content may flow from the interior of the pump body along a flow path from toward an outlet end of the conduit, with a valve made of a resilient flexible polymer material different from the plastics material and biased to allow flow from the interior of the pump body toward the dispensing opening provided in the flow path.

15. A pumping piston according to claim 14 wherein the valve is a flap valve comprising a resilient flap biased to open in response to flow of fluid material toward the dispensing opening and closed to flow in the opposite direction.

16. A pumping piston according to claim 14 wherein the valve is a flap valve comprising two or more convergent flaps biased closed against each other and which part in response to flow toward the dispensing opening.

17. A pumping piston according to claim 14 wherein the resilient flexible polymer material different from the plastics material is an elastomer material.

18. A pumping piston according to claim 14 wherein a barrier layer of a resiliently flexible polymer material on the pumping piston is integrally formed with such a valve.

19. A dispensing pump for a viscous fluid material, in particular for a dentifrice such as a toothpaste or tooth-cleaning gel, provided with a pumping piston and/or a floating piston according to any one of the preceding claims.

20. A process for making a pumping piston according to claim 1 wherein a plastics material part of the piston is made first, and is then enclosed in a mould defining the shape of the barrier layer, and the barrier layer of an injectable polymer material is formed by injecting the barrier layer material into the mould to form the barrier layer in contact with the plastics material.

21. A process for making a floating piston according to claim 6 wherein a plastics material part of the piston is made first, and is then enclosed in a mould defining the shape of the barrier layer, and the barrier layer of an injectable polymer material is formed by injecting the barrier layer material into the mould to form the barrier layer in contact with the plastics material.

22. A floating piston according to claim 6 wherein the barrier layer is a material which has a lower permeability toward a component of the viscous fluid material and/or toward a component of the environment, than the permeability toward the component(s) of the plastic material.

23. A floating piston according to claim 6 wherein the barrier layer is a material having a low friction with the inner surface of the body and able to form a sliding seal with the inner surface of the body, and part of the rim which forms the sliding seal is made of the material of the barrier layer.
